(19) United States
(12) Patent Application Publication
(10) Pub. No.: US 2025/0216924 A1
(43) Pub. Date: Jul. 3, 2025

(54) POWER MANAGEMENT SYSTEM AND COMPUTER APPARATUS

(71) Applicant: Fulian Precision Electronics (Tianjin) Co., Ltd., Tianjin (CN)

(72) Inventor: XIAO-LONG ZHOU, Tianjin (CN)

(21) Appl. No.: 18/752,856

(22) Filed: Jun. 25, 2024

(30) Foreign Application Priority Data
Dec. 29, 2023 (CN) 202311871299.3

(51) Int. Cl. G06F 1/3246; H02J 1/10

(52) U.S. Cl. CPC G06F 1/3246; H02J 1/10

(57) ABSTRACT

A power management system includes a power supply unit a first power supply, a second power supply, a Complex Programmable Logic Device (CPLD), and a motherboard chipset. The first power supply receives electrical energy of the power supply unit and powers the CPLD. The second power supply receives the electrical energy of the power supply unit and powers the CPLD, the motherboard chipset, and a target component. The motherboard chipset enters a sleep mode in response to a sleep request and output a sleep instruction to the CPLD. The CPLD outputs a sleep control signal to the second power supply in response to the sleep instruction. The second power supply stops powering the motherboard chipset and the target component in response to the sleep control signal, for maximizing power saving while the power management system is in the sleep. A computer apparatus is also provided.

### TECHNICAL FIELD

The present application generally relates to power management technology, and particular to power management system and a computer apparatus.

### BACKGROUND

Existing computer apparatuses, such as a server and a computer, and so on, usually includes a deep sleep function. During a period of the deep sleep, system information of the computer apparatus is suspended to a hard disk. Most power supplies of the computer apparatus are shut off, for achieving a purpose of power saving.

In a related art, traditional power management schemes usually only turn off a main power supply, or a power switch and related power control circuit via PCH control PCA for turning off part of standby power supplies. Thus, there is not enough power supplies being turned off to maximize power savings.

There is room to for improvement in the art.

### BRIEF DESCRIPTION OF THE DRAWINGS

Implementations of the present application will now be described, by way of example only, with reference to the attached figures.

FIG. 1 is a diagram illustrating a first embodiment of a power management system according to the present application.

FIG. 2 is a diagram illustrating a second embodiment of a power management system according to the present application.

FIG. 3 is a diagram illustrating a third embodiment of a power management system according to the present application.

FIG. 4 is a diagram illustrating a fourth embodiment of a power management system according to the present application.

FIG. 5 is a diagram illustrating a fifth embodiment of a power management system according to the present application.

### DETAILED DESCRIPTION

It should be understood that, the term “at least one” of the present application means one or multiple. The term “multiple” means two or more. The term “multiple” means two or more. The term “and/or” of the present application merely describes associations between associated objects, and it indicates three types of relationships. For example, “A and/or B” may indicate A alone, A and B, or B alone. “A” and “B” may be singular or plural, respectively. In the description of the present application, the terms such as “first”, or “second”, “third”, “fourth” (if exist), and the like are used only to distinguish between different objects, and are not to be understood as indicating or implying a relative importance or implicitly specifying the number, particular order, or primary and secondary relation of the technical features indicated.

In addition, it should be noted that the methods disclosed in the embodiments of the present disclosure or the methods shown in the flowcharts include one or more blocks for implementing the methods, and the one or more blocks are not deviated from the scope of the claims. The order of execution can be interchanged with each other, and some of the one or more blocks can also be deleted.

Unless otherwise defined, all technical and scientific terms used herein have the same meaning as commonly understood by those skilled in the technical field of the present application. The terms used in the specification of the present application herein are only for the purpose of describing specific embodiments, and are not intended to limit the present application.

In a related art, traditional power management schemes usually only turn off a main power supply, or a power switch and related power control circuit via PCH control PCA for turning off part of standby power supplies. Thus, there is not enough power supplies being turned off to maximize power savings.

The present application provides a power management system and a computer apparatus, which are configured to turn off enough power supplies for maximizing power saving when a sleep function is enabled.

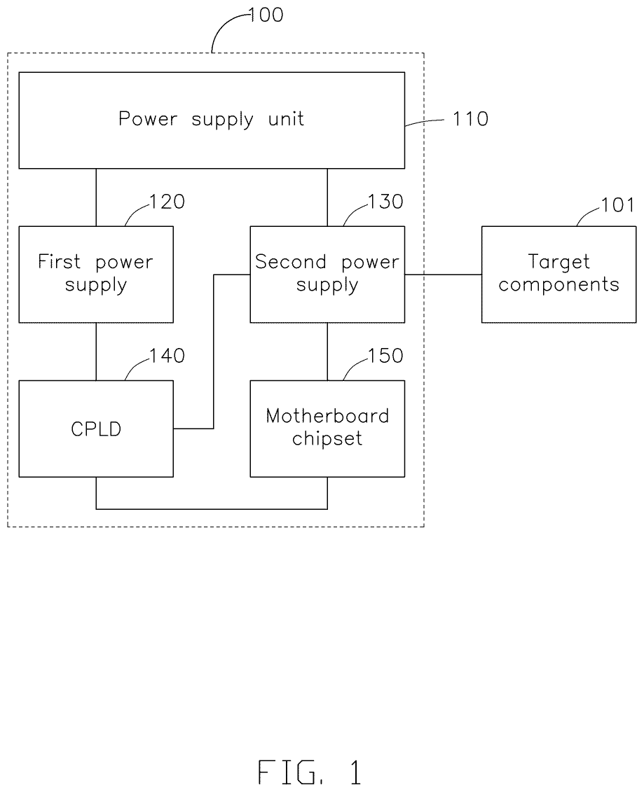

Referring to FIG. 1, FIG. 1 shows a diagram of a power management system 100 of a first embodiment of the present application. The power management system 100 may include a power supply unit 110, a first power supply 120, a second power supply 130, a Complex Programmable Logic Device (CPLD) 140, and a motherboard chipset 150.

The first power supply 120 is electrically connected with the power supply unit 110 and the CPLD 140, and is configured to receive an electrical energy of the power supply unit 110 and power the CPLD 140. The second power supply 130 is electrically connected with the power supply unit 110, the motherboard chipset 150, and the CPLD 140, and is configured to receive the electrical energy of the power supply unit 110 and power the CPLD 140, the motherboard chipset 150, and a target component 101.

In the embodiment of the present application, the motherboard chipset 150 is electrically connected with the CPLD 140. The motherboard chipset 150 is configured to enter a sleep mode in response to a sleep request, and output a sleep instruction to the CPLD 140. The CPLD 140 outputs a sleep control signal to the second power supply 130 in response to the sleep instruction. The second power supply 130 stops powering the motherboard chipset 150 and the target component 101 in response to the sleep control signal.

In a computer apparatus, the motherboard chipset 150 may be a Platform Controller Hub (PCH), for example, including northbridge chip and southbridge chip of a computer motherboard. The sleep request is generated according to operations of the computer apparatus by an operator, for example, in a computer with the above power management system 100, the operator may execute an operation of sleep via an operation interface of the computer, thus the sleep request is generated and transmitted to the motherboard chipset 150.

In the embodiment of the present application, the above first power supply 120 may only powers the CPLD 140, for ensuring a stability of the functions of sleep and awake of the power management system 100. The first power supply 120 may include a voltage regulator. The voltage regulator is electrically connected with the power supply unit 110 and the CPLD 140. The voltage regulator is configured to receive a power supply voltage of the power supply unit 110 and convert the power supply voltage into a working voltage of the CPLD 140.

It is understood that, the present application sets the CPLD to control the second power supply 130, for stopping powering the target component 101 and further stopping powering the motherboard chipset 150 while the system sleeps. Therefore, the power management system 100 maximizes the power saving while sleeping.

In some embodiments, the above CPLD 140 also responses to a wake instruction, and outputs a waking signal to the motherboard chipset 150 and the second power supply 130. The motherboard chipset 150 also may enter a standby state in responses to the waking signal. The second power supply 130 also may power the motherboard chipset 150 and the target component 101 in response to the waking signal.

In some embodiments, the above CPLD 140 also retains a waking function and disables other functions itself in response to the sleep instruction. The CPLD 140 also starts all the functions itself in response to the waking instruction.

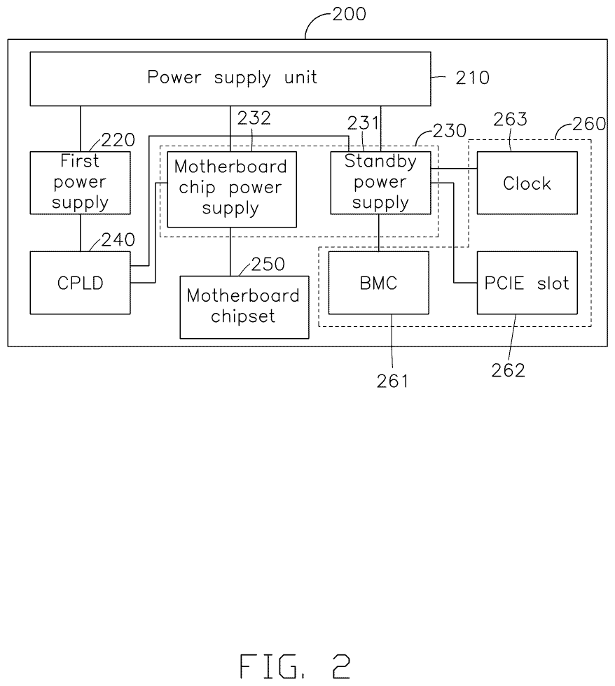

Referring to FIG. 2, FIG. 2 shows a diagram of a second embodiment of the power management system 200 of the present application. The power management system 200 includes a power supply unit 210, a first power supply 220, a second power supply 230, a CPLD 240, a motherboard chipset 250, and a target component 260.

The first power supply 220 is electrically connected with the power supply unit 210 and the CPLD 240, and is configured to receive an electrical energy of the power supply unit 210 and power the CPLD 240. The second power supply 230 is electrically connected with the power supply unit 210, the motherboard chipset 250, and the CPLD 240, and is configured to receive the electrical energy of the power supply unit 210 and power the CPLD 240, the motherboard chipset 250, and the target component 260.

The second power supply 220 includes a standby power supply 231 and a motherboard chip power supply 232. The target component 260 includes a Baseboard Management Controller (BMC) 261, and a Peripheral Component Interconnect Express (PCIE) slot 262, and a clock 263. The standby power supply 231 is electrically connected with the power supply unit 210, the BMC 261, the PCIE slot 262, the clock 263, and the motherboard chipset 250. The motherboard chip power supply 232 is electrically connected to the power supply unit 210 and the motherboard chipset 250.

In the embodiment of the present application, the motherboard chipset 250 is electrically connected with the CPLD 240, and is configured to enter a sleep mode in response to a sleep request, and output a sleep instruction to the CPLD 240. The CPLD 240 outputs a sleep control signal to the second power supply 230 in response to the sleep instruction. The second power supply 230 stops powering the motherboard chipset 250 and the target component 260 in response to the sleep control signal.

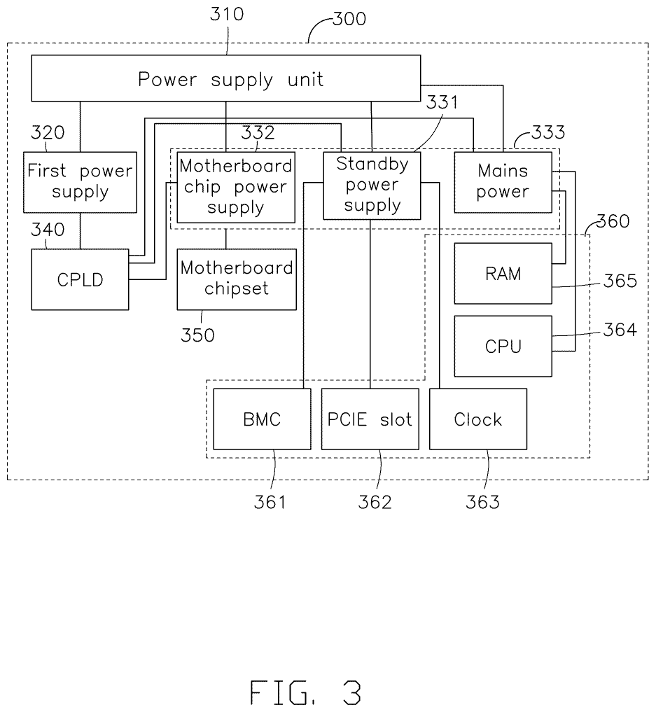

Referring to FIG. 3, FIG. 3 shows a diagram of a third embodiment of the power management system 300 of the present application. As shown in FIG. 3, the power management system 300 includes a power supply unit 310, a first power supply 320, a second power supply 330, a CPLD 340, a motherboard chipset 350, and a target component 360.

By comparing the power management system 300 as shown in FIG. 3 with the power management system 200 as shown in FIG. 2, the difference is that the second power supply of the power management system 300 further includes a main power supply 333 besides including a standby power supply 331 and a motherboard chip power supply 332. The target component 360 further includes a Central Processing Unit (CPU) 364 and a Random Access Memory (RAM) besides including the BMC 361, the PCIE slot 362, and the clock 363. The main power supply 333 is electrically connected with the power supply unit 310, the CPU 364, and the RAM 365.

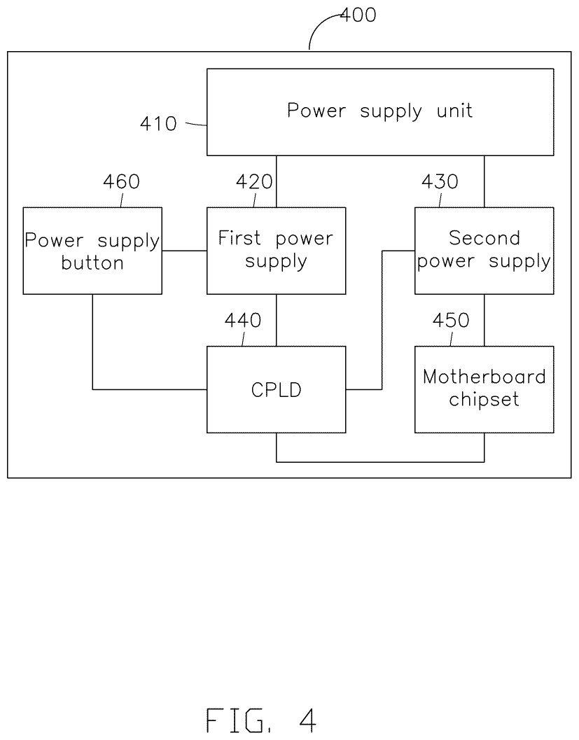

Referring to FIG. 4, FIG. 4 shows a diagram of a fourth embodiment of the power management system 400. As shown in FIG. 4, the power management system 400 includes a power supply unit 410, a first power supply 420, a second power supply 430, a CPLD 440, and a motherboard chipset 450.

By comparing the power management system 400 as shown in FIG. 4 with the power management system 100 in FIG. 1, the difference is that the power management system 400 as shown in FIG. 4 further includes a power supply button 460. The power supply button 460 is electrically connected with the first power supply 420 and the CPLD 440. The first power supply 420 is further configured to power the power supply button 460. The power supply button 460 is configured to generate and transmit a wake instruction while being pressed.

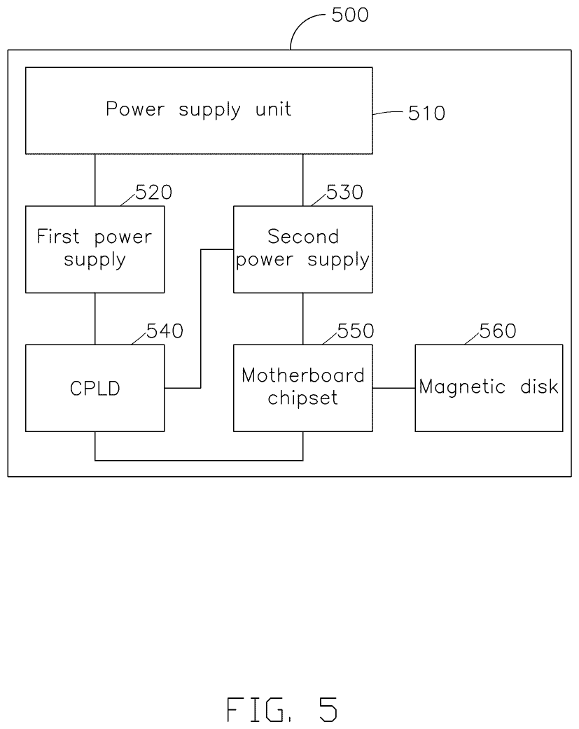

Referring to FIG. 5, FIG. 5 shows a diagram of a fifth embodiment of a power management system 500 of the present application. As shown in FIG. 5, the power management system 500 further includes a power supply unit 510, a first power supply 520, a second power supply 530, a CPLD 540, and a motherboard chipset 550.

By comparing the power management system 500 as shown in FIG. 5 with the power management system 100 in FIG. 1, the difference is that the power management system 500 as shown in FIG. 5 further includes a magnetic disk 560. The magnetic disk 560 is electrically connected with the motherboard chipset 550.

In the embodiment of the present application, the motherboard chipset 550 is further configured to store running information into the magnetic disk 560 in response to the sleep request. The motherboard chipset 550 is further configured to acquire and resume the running information from the magnetic disk 560 in response to the waking signal.

The embodiment of the present application further provided a computer apparatus, including any above embodiments of the power management system. It is understood that, the beneficial effects that may be achieved by the computer apparatus, refer to the foregoing corresponding beneficial effects of the power management system.

The foregoing described embodiments are only exemplary embodiments of this application, and are not intended to limit the scope of this application. Without departing from design spirit of this application, various transformations and improvements made by a person of ordinary skill in the art to the technical solutions of this application shall fall within the protection scope defined in claims of this application.

What is claimed is:

1. A power management system used in a computer apparatus, wherein the power management system comprises a power supply unit a first power supply, a second power supply, a Complex Programmable Logic Device (CPLD), and a motherboard chipset; the first power supply is electrically connected with the power supply unit and the CPLD and is configured to receive electrical energy of the power supply unit and power the CPLD; the second power supply is electrically connected with the power supply unit, the motherboard chipset, and the CPLD and is configured to receive the electrical energy of the power supply unit and power the CPLD, the motherboard chipset, and a target component; the motherboard chipset is electrically connected with the CPLD; the motherboard chipset is configured to enter a sleep mode in response to a sleep request and output a sleep instruction to the CPLD; the CPLD outputs a sleep control signal to the second power supply in response to the sleep instruction; the second power supply stops powering the motherboard chipset and the target component in response to the sleep control signal.

2. The power management system of claim 1, wherein the CPLD also responses to a wake instruction, and outputs a waking signal to the motherboard chipset and the second power supply; the motherboard chipset also may enter a standby state in responses to the waking signal; the second power supply also may power the motherboard chipset and the target component in response to the waking signal.

3. The power management system of claim 1, wherein the second power supply comprises a standby power supply and a motherboard chip power supply; the target component comprises a Baseboard Management Controller (BMC), and a Peripheral Component Interconnect Express (PCIE) slot, and a clock; the standby power supply is electrically connected with the power supply unit, the BMC, the PCIE slot, the clock, and the motherboard chipset; the motherboard chip power supply is electrically connected to the power supply unit and the motherboard chipset.

4. The power management system of claim 3, wherein the power management system further comprises a main power supply; the target component further comprises a Central Processing Unit (CPU) and a Random Access Memory (RAM); the main power supply is electrically connected with the power supply unit, the CPU, and the RAM.

5. The power management system of claim 2, wherein the power management system further comprises a power supply button; the power supply button is electrically connected with the first power supply and the CPLD; the first power supply is further configured to power the power supply button; the power supply button is configured to generate and transmit the wake instruction while being pressed.

6. The power management system of claim 2, wherein the power management system further comprises a magnetic disk; the magnetic disk is electrically connected with the motherboard chipset; the motherboard chipset is further configured to store running information into the magnetic disk in response to the sleep request.

7. The power management system of claim 6, wherein the motherboard chipset is further configured to acquire and resume the running information from the magnetic disk in response to the waking signal.

8. The power management system of claim 2, wherein the CPLD is further retains a waking function and disables other functions itself in response to the sleep instruction.

9. The power management system of claim 8, wherein the CPLD is further configured to start all functions itself in response to the waking instruction.

10. A computer apparatus comprises a power management system; wherein the power management system comprises a power supply unit a first power supply, a second power supply, a Complex Programmable Logic Device (CPLD), and a motherboard chipset; the first power supply is electrically connected with the power supply unit and the CPLD and is configured to receive electrical energy of the power supply unit and power the CPLD; the second power supply is electrically connected with the power supply unit, the motherboard chipset, and the CPLD and is configured to receive the electrical energy of the power supply unit and power the CPLD, the motherboard chipset, and a target component; the motherboard chipset is electrically connected with the CPLD; the motherboard chipset is configured to enter a sleep mode in response to a sleep request and output a sleep instruction to the CPLD; the CPLD outputs a sleep control signal to the second power supply in response to the sleep instruction; the second power supply stops powering the motherboard chipset and the target component in response to the sleep control signal.

11. The computer apparatus of claim 10, wherein the CPLD also responses to a wake instruction, and outputs a waking signal to the motherboard chipset and the second power supply; the motherboard chipset also may enter a standby state in responses to the waking signal; the second power supply also may power the motherboard chipset and the target component in response to the waking signal.

12. The computer apparatus of claim 10, wherein the second power supply comprises a standby power supply and a motherboard chip power supply; the target component comprises a Baseboard Management Controller (BMC), and a Peripheral Component Interconnect Express (PCIE) slot, and a clock; the standby power supply is electrically connected with the power supply unit, the BMC, the PCIE slot, the clock, and the motherboard chipset; the motherboard chip power supply is electrically connected to the power supply unit and the motherboard chipset.

13. The computer apparatus of claim 12, wherein the power management system further comprises a main power supply; the target component further comprises a Central Processing Unit (CPU) and a Random Access Memory (RAM); the main power supply is electrically connected with the power supply unit, the CPU, and the RAM.

14. The computer apparatus of claim 11, wherein the power management system further comprises a power supply button; the power supply button is electrically connected with the first power supply and the CPLD; the first power supply is further configured to power the power supply button; the power supply button is configured to generate and transmit the wake instruction while being pressed.

15. The computer apparatus of claim 11, wherein the power management system further comprises a magnetic disk; the magnetic disk is electrically connected with the motherboard chipset; the motherboard chipset is further configured to store running information into the magnetic disk in response to the sleep request.

16. The computer apparatus of claim 15, wherein the motherboard chipset is further configured to acquire and resume the running information from the magnetic disk in response to the waking signal.

17. The computer apparatus of claim 11, wherein the CPLD is further retains a waking function and disables other functions itself in response to the sleep instruction.

18. The computer apparatus of claim 17, wherein the CPLD is further configured to start all functions itself in response to the waking instruction.
